(19) United States
(12) Patent Application Publication
(10) Pub. No.: US 2006/0294327 A1
(43) Pub. Date: Dec. 28, 2006

(54) Method, apparatus and system for optimizing interleaving between requests from the same stream

(76) Inventors: Debendra Das Sharma, Santa Clara, CA (US); Lesley L. Chang, San Jose, CA (US); Michelle C. Jen, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/166,492

(22) Filed: Jun. 23, 2005

(51) Int. Cl. G06F 13/28

(52) U.S. Cl. 711/157

(57) ABSTRACT

A device includes a first memory that includes a page in progress field. A read processing engine is connected to the first memory. The read processing engine to interleave read requests based on the page in progress field.

### BACKGROUND

1. Field

Embodiments relate to a method, apparatus and system for reducing read request latency, and in particular a method, apparatus and system for optimizing processing of interleaved read requests.

2. Description of the Related Art

In today's computers, computer systems, processing devices, etc. it is important to reduce latency in servicing memory requests. One way to assist reducing latency is to interleave memory requests. Existing interleaving techniques do not consider where a stream of memory requests originated. With prior art techniques, for example, suppose an input/output device receives a large memory request (e.g., 4 kB). The input/output device might split the request into multiple smaller requests (e.g., 256B) before sending to another device. The smaller requests from the same original input/output device's large request are part of the same “stream” in the other device.

Since requests from the same stream must be completed in order by the input/output device, it is not optimal for the other device to interleave those requests because the situation can arise where a later request completes and must wait for the earlier requests to complete before it can continue. In the case of multiple streams, interleaving the requests is useful and enables all streams to make progress. This avoids having one stream fully complete, while the other streams have made no progress at all. However, because the streams are broken down before reaching the other device, it is not possible to know which requests are from which streams.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates an embodiment including a page in progress field in a look-up memory.

FIG. 2 illustrates an embodiment of a layout of a look-up memory having a page in progress field.

FIG. 3 illustrates a block diagram of an embodiment illustrating request paths.

FIG. 4 illustrates a system of an embodiment including the device illustrated in FIG. 1.

FIG. 5 illustrates a block diagram of a process to reduce request latency.

### DETAILED DESCRIPTION

The embodiments discussed herein generally relate to a method, system and apparatus for improving memory read request processing by tracking memory page requests. Referring to the figures, exemplary embodiments will now be described. The exemplary embodiments are provided to illustrate the embodiments and should not be construed as limiting the scope of the embodiments.

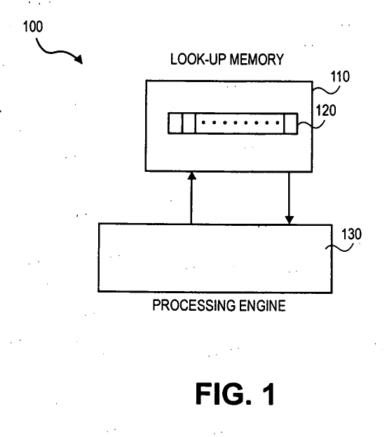

FIG. 1 illustrates an embodiment including a look-up memory having a structure with many fields where one of the fields is a page in progress field. In one embodiment device 100 includes first memory 110. In one embodiment memory 110 is a content addressable memory (CAM). In another embodiment, memory 110 is a look-up memory device, such as a look-up process in a look-up engine or a table-look up process and a memory device, such as a dual in-line memory (DIMM), random-access memory (RAM), static random access memory (SRAM), dynamic random access memory (DRAM), synchronous DRAM (SDRAM), read-only memory (ROM), etc. In one embodiment, memory 110 has a structure with a plurality of fields, such as 4, 8, 16, 32, etc. fields. In one embodiment, one field of memory 110 is page in progress field 120. In this embodiment, page in progress field 120 can be one bit, two bits, etc. wide. In one embodiment, page in progress field 120 is used as a counter and is incremented and decremented.

Device 100 includes read processing engine 130 that is coupled to first memory 110. In one embodiment read processing engine 130 functions to interleave read requests based on page in progress field 120. In one embodiment, read processing engine 130 includes partitioning logic to partition read requests into cache-line sized read requests. In this embodiment, a read request can be interleaved into a stream of smaller sized read requests. In one embodiment read processing engine 130 includes a programmable device (e.g., an erasable programmable read-only memory (EPROM), electrically EPROM (EEPROM), flash memory, etc.) that can be programmed to perform interleaving of read requests when the read requests are from different memory pages. In this embodiment, existing systems having a read processing engine or read processor and a look-up memory (e.g., a CAM) or look-up process can be reprogrammed to interleave read requests when read requests are from different memory pages and to complete a read interleaved request when a subsequent read request from the same memory page is received.

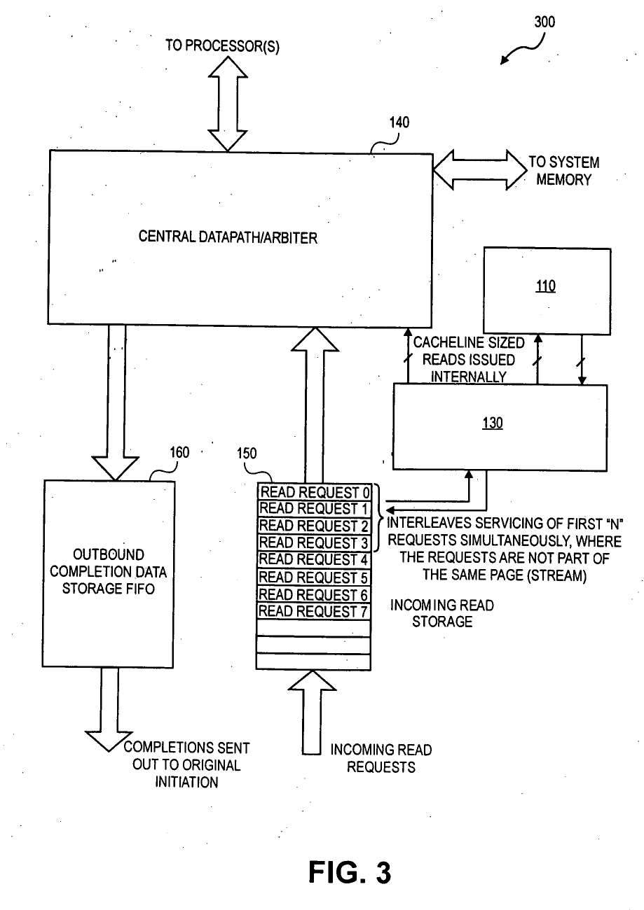

In another embodiment a second memory (see FIG. 3, memory 150) is coupled to read processing engine 130. In this embodiment the second memory functions to store incoming read requests. In one embodiment, the second memory is a first-in/first-out (FIFO) memory. In another embodiment read processing engine 130 includes a process to interleave read requests when the read requests are from different memory pages. In one embodiment read processing engine uses page in progress field 120 to keep track of which pages of memory are already being requested by comparing the addresses of read requests that are stored in first memory 110 and checking page in progress field 120 for non-zero values. When a read request originates, the address of the page is stored in first memory 110. The page in progress field 120 is incremented for the read request to the specific page of memory. If another read request is made for the same page of memory, page in progress field 120 is incremented again. When the first memory 110 is checked for pages in progress, if the page in progress field 120 is non-zero, then no interleaving of the read request is made (until the page in progress field is zero for the particular page of memory).

In one embodiment, a system already including a look-up memory, such as a CAM, and a processing engine can be modified to include a page in progress field 120. In this embodiment, input data into the first memory 110 is compared against a list of stored entries. An item stored in memory is accessed by its content rather than by its address. In this embodiment, by using similar existing structures, the page-in-progress bits can be implemented with very little additional logic since it is an additional field in the existing memory structure.

In one embodiment, the page-in-progress bits in page in progress field 120 are set as follows: when first memory 110 determines that a read request is stored, page-in-progress field 120 is incremented for the corresponding address tag. When the read request completes, page-in-progress field 120 is decremented. If page-in-progress field 120 is non-zero, then new read requests to the same page in memory will not be processed until older read requests are complete. It should be noted that other embodiments use other strategies for modifying page in progress field 120, such as the reverse of above (i.e., decrementing instead of incrementing, and vice versa).

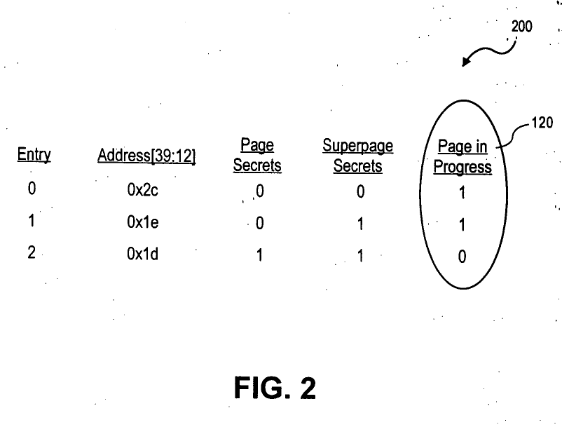

FIG. 2 illustrates a field structure 200 for one embodiment having first memory 110 and page in progress field 120. In this embodiment, three (3) read request entries are stored in first memory 110. Additionally, shown as an example of other fields are: address, page secrets (i.e., whether a page is accessible (no secret) by an I/O device; e.g., a logical value of “0” can mean that the page is accessible (secret), a “value of “1” can mean that the page is not accessible, or vice versa) and superpage secrets, where a superpage is a collection of contiguous pages (e.g., aligned 64 pages) and the secret is whether all the pages are accessible or not (e.g., a logical value of “0” can mean all the pages are accessible by an I/O device, otherwise the value is “1”, or vice versa). In memory structure 200 address [39:12] is used to index into first memory 110. Only bits [39:12] are needed to keep track of a memory page (e.g., a 4 kByte memory page) as all addresses with the same [39:12] bits are in the same page range.

FIG. 3 illustrates an embodiment illustrating read request paths. In this embodiment, device 300 includes first memory 110, read processing engine 130, second memory 150, a third memory 160 and central datapath/arbiter 140. In one embodiment, read requests enter second memory 150 and are stored in a FIFO arrangement. Read processing engine 130 interleaves servicing of first “n” read requests where the read requests are not part of the same memory page. Read processing engine 130 reads first memory 110 page in progress field 120 and increments/decrements page in progress field 120 accordingly. The status of page in progress field 120 is returned to read processing engine 130. If the status of page in progress field for the current read request is zero, read processing engine 130 partitions the read request into cacheline sized read requests and issues the partitioned read requests to central datapath/arbiter 140, interleaving issuing of these cacheline-sized reads with reads for requests for other streams. If the status of page in progress field 120 is returned as non-zero (i.e., a previous read request is from the same memory page as a current read request) then read processing engine 130 does not issue any reads for the current request until all previous requests to the same page have had their reads issued. For instance, in FIG. 3, if read request 0, 2 and 3 are part of unique page streams but request 1 is part of the same page stream as request 0, read processing engine 130 could interleave issuing reads for requests 0, 2 and 3 simultaneously but would not issue any reads for request 1 until all reads have been issued for request 0. As the read requests are processed, central datapath/arbiter 140 passes read completions to third memory 160. In one embodiment, third memory 160 arranges completed requests in a FIFO arrangement.

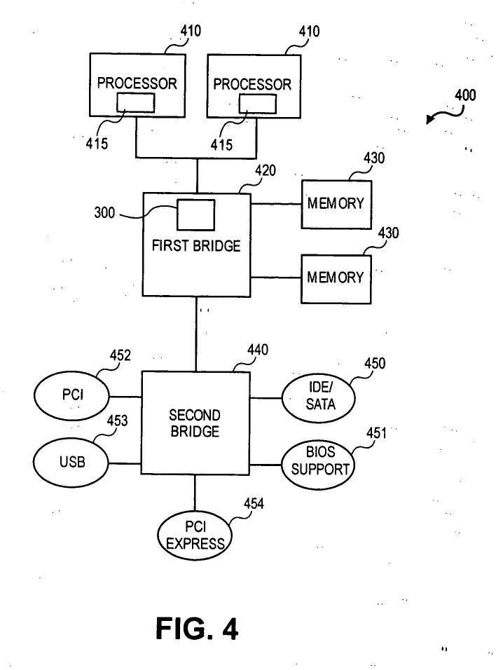

FIG. 4 illustrates an embodiment of a system. System 400 includes one or more processors 410 (e.g., multiprocessor, central processing unit, etc.), memory 415 (e.g., a cache memory) connected to processor 410, device 300, including processing engine 130, is connected to processor(s) 410, and first memory 110 (e.g., a look-up memory, a CAM, etc.) is connected to processing engine 130. In this embodiment first memory 110 includes page in progress field 120. Processing engine 130 interleaves page requests based on page in progress field 120.

In one embodiment system 400 includes first bridge 420 connected to processor(s) 410, second bridge 440 connected to first bridge 420, and at least one input/output device (e.g., 450, 451, 452, 453) connected to second bridge 440. In one embodiment, input/output device 450 is one or more integrated drive electronics (IDE)/serial ATA (SATA) device(s). In one embodiment input/output device 451 is a device for supporting a basic input/output system (BIOS). In one embodiment input/output device 452 is a peripheral component interconnects (PCI) device. In another embodiment, input/output device 453 is a universal serial bus (USB) device. In yet another embodiment, input/output device 454 is a PCI express device. It should be noted that other types of devices requiring input/output (I/O) can also be connected to second bridge 440.

In another embodiment, at least one memory 430 is connected to first bridge 420. In one embodiment memory 430 is main memory, such as a DIMM, RAM, SRAM, DRAM, SDRAM, ROM, etc. By interleaving only those read requests from different pages for servicing read requests, system 400 using device 300 decreases latency by adjusting the order in which read requests are processed.

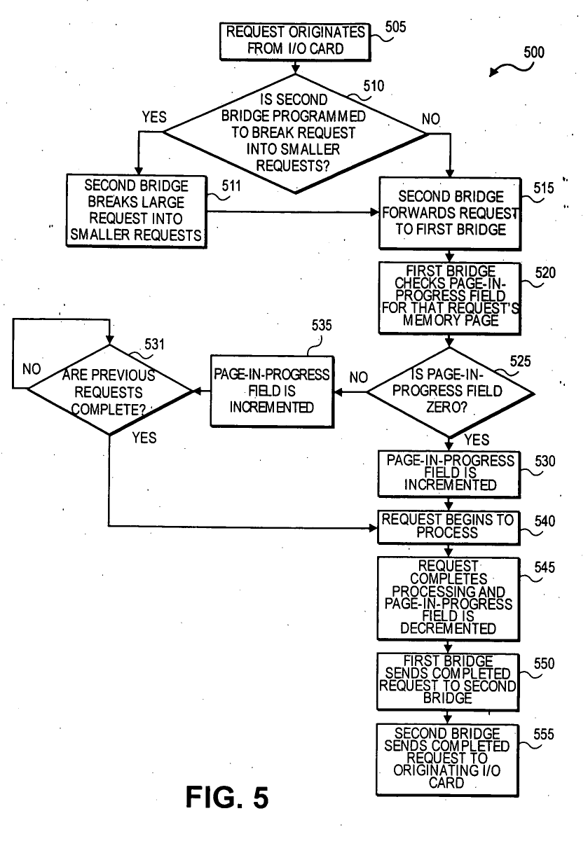

FIG. 5 illustrates a flow diagram of a process of an embodiment. Process 500 begins with block 505 where a read request originates from an I/O device/card, such as a PCI card, input/output device 450, 451, 452, 453, etc. that is/are connected to a second bridge (e.g., second bridge 440). In one embodiment block 510 determines if a second bridge (e.g., second bridge 440) has logic to partition a read request into a stream of smaller requests. If block 510 determines that logic is present to partition read requests into a stream of smaller requests then process 500 continues with block 511.

At block 511 the second bridge partitions large read requests (e.g., 4 kB) into a stream of smaller read requests. After block 511, and if block 510 determines the second bridge does not contain logic to partition read requests into a stream of smaller sized requests, process 500 continues with block 515.

In block 515 the second bridge forwards the read request to the first bridge (e.g., first bridge 420) where the read requests are received. In block 520 the first bridge determines the status of a page in progress field (e.g., page in progress field 120) contained in a memory (e.g., a CAM) for the page of memory for which the received read request is part. Process 500 continues with block 525 where the page in progress is checked to see if it has a zero value (i.e., the current read request is not part of any read requests that are being serviced having the same memory page). If block 525 determines the page in progress field is not zero, then process 500 continues with block 535.

In block 535, since the current read request belongs to the same page of memory as a previously submitted read request, the page in progress field is incremented to identify the number of read requests received that are from the same page of memory. Process 500 continues with block 531 where a check is made to see if the previous read request belonging to the same memory page is complete. The check continues until the previously submitted read request is completed. If block 525 determines the page in progress field is not zero, process 500 continues with block 530 where the page in progress field is incremented. Process 500 continues with block 540 when block 530 is completed or when block 531 determines the previous received read requests are complete.

In block 540 the current read request is serviced. Process 500 continues with block 545 where the read request is completed and the page in progress field is decremented for the current read request's associated memory page. In block 550 the completed read request is transmitted to the second bridge. In block 550 the second bridge forwards the completed read request to the originating I/O device/card. It should be noted that partial completions for the request (i.e., resulting from the cacheline partitioning) can be forwarded to the second bridge as soon as they are received from system memory. Therefore, it is not necessary for the entire request to be processed before forwarding data back to the second bridge.

Some embodiments can also be stored on a device or machine-readable medium and be read by a machine to perform instructions. The machine-readable medium includes any mechanism that provides (i.e., stores and/or transmits) information in a form readable by a machine (e.g., a computer, PDA, cellular telephone, etc.). For example, a machine-readable medium includes read-only memory (ROM); random-access memory (RAM); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines. In one embodiment read processing engine 130 can be replaced with a virtual read processing engine that is a process initiated by a processor. In this embodiment, instructions are stored in a memory and read by a machine, such as the processor, to perform the instruction.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one element. If the specification or claims refer to “an additional” element, that does not preclude there being more than one of the additional element.

What is claimed is:

1. An apparatus comprising:
a first memory including a page in progress field, and
a read processing engine coupled to the first memory,
the read processing engine to interleave read requests based on the page in progress field.

2. The apparatus of claim 1, wherein the first memory comprises:
a content addressable memory.

3. The apparatus of claim 1, wherein the read processing engine comprises:
partitioning logic to partition read requests into cache-line sized read requests.

4. The apparatus of claim 1, further comprising:
a second memory coupled to the read processing engine, the second memory to store incoming read requests.

5. The apparatus of claim 1, wherein the processing engine includes:
a process to interleave read requests when the read requests are from different memory pages.

6. A system comprising:
at least one processor coupled to a cache memory;
a processing engine coupled to the processor, and
a look-up memory coupled to the processing engine, the look-up memory including a page in progress field, the processing engine to interleave page requests based on the page in progress field.

7. The system of claim 6, wherein the look-up memory is a content addressable memory.

8. The system of claim 6, further comprising:
a first bridge coupled to the processor;
a second bridge coupled to the first bridge, and
at least one input/output device coupled to the second bridge.

9. The system of claim 6, wherein the processing engine includes:
a programmable device to interleave read requests when the read requests are from different memory pages.

10. The system of claim 6, further comprising:
a device included in the processing engine to interleave read requests when the read requests are from different memory pages.

11. A method comprising:
issuing a request from a second bridge;
receiving the request at a first bridge;
determining a value of a page in progress field included in a memory, and
servicing the request if the page in progress field has a first value,
wherein the first value indicates the request is from a different memory page than a previous read request.

12. The method of claim 11, further comprising:
servicing previous requests if the page in progress field has a value different from the first value, and
changing the page in progress field if the request is completed.

13. The method of claim 12, further comprising:
sending a completed request from the first bridge to the second bridge, and
sending the completed request from the second bridge to an input/output device.

14. The method of claim 13, further comprising:
determining if the second bridge can partition the request into a plurality of smaller sized requests, and
partitioning the request into the plurality of smaller sized requests if it is determined that the second bridge can partition the request into the plurality of smaller sized requests.

15. The method of claim 11, wherein determining comprises:
accessing a content addressable memory to read the page in progress field.

16. A machine-accessible medium containing instructions that, when executed, cause a machine to:
determine a value of a page in progress field, and
service a read request if the page in progress field has a first value,
wherein the first value indicates the read request is from a different memory page than a previous read request.

17. The machine-accessible medium of claim 16, further containing instructions that, when executed, cause a machine to:
issue the read request from a second device;
receive the read request at a first device, and
service previous read requests if the page in progress field is different from the first value.

18. The machine-accessible medium of claim 17, further containing instructions that, when executed, cause a machine to:
send a completed read request from the second device to an input/output device.

19. The machine-accessible medium of claim 16, further containing instructions that, when executed, cause a machine to:
determine if the second device can partition the read request into a stream of smaller sized read requests.

20. The machine-accessible medium of claim 16, wherein the determine further containing instructions that, when executed, cause a machine to: access a look-up memory to read the page in progress field.
